(19) United States
(12) Patent Application Publication
(10) Pub. No.: US 2022/0414726 A1
(43) Pub. Date: Dec. 29, 2022

(54) BLOCKCHAIN-BASED PERMISSIONS LEDGER FOR METAVERSE IMPLEMENTATION

(71) Applicant: Human Mode, L.L.C., Oklahoma City, OK (US)

(72) Inventor: William Xavier Kerber, Oklahoma City, OK (US)

(73) Assignee: Human Mode, L.L.C., Oklahoma City, OK (US)

(21) Appl. No.: 17/847,989

(22) Filed: Jun. 23, 2022

Related U.S. Application Data
(60) Provisional application No. 63/214,240, filed on Jun. 23, 2021.

(51) Int. Cl. G06Q 30/06; G06Q 30/00; H04L 9/00

(52) U.S. Cl. CPC G06Q 30/0601; G06Q 30/018; H04L 9/50; G06Q 50/16

(57) ABSTRACT

A method for managing participant permissions within a computer-implemented metaverse includes steps for storing unique permissions and object attributes in a blockchain data structure. A method for managing transactions involving virtual real estate in a computer-implemented metaverse includes the steps of permitting a human participant to access the computer-implemented metaverse with a client device, identifying a virtual real estate parcel within the computer-implemented metaverse for sale by a seller, verifying with the blockchain data structure that the seller is the owner of record of the target virtual real estate parcel, transferring funds from the account assigned to the participant to an account assigned to the seller, and recording in the blockchain data structure the transfer of the virtual real estate parcel from the account assigned to the seller to the account assigned to the participant.

### RELATED APPLICATIONS

The present application claims the benefit of U.S. Provisional Patent Application Ser. No. 63/214,240 filed Jun. 23, 2021 and entitled, “Blockchain-Based Permissions Ledger for Metaverse Implementation,” the disclosure of which is hereby incorporated by reference as if fully set forth herein.

### FIELD OF INVENTION

The present invention relates generally to the field of metaverses and other computer-implemented virtual environments that can be adapted for online gaming, shopping and social platforms, and more particularly, but not by way of limitation, to systems for controlling permissions and property rights within such virtual environments.

### BACKGROUND OF INVENTION

Online and virtual worlds are rapidly increasing in both size and complexity. Recently, the term “metaverse” has been used to describe a live and persistent online environment with both planned and spontaneous events always occurring. A metaverse may provide gaming, entertainment, shopping and social engagement functions that span and operate across multiple, distributed computer platforms.

To accommodate the increasingly complex nature of metaverses and other online environments, it is important to provide a system for controlling, monitoring and transacting certain rights, permissions and authorities within the virtual world. As participants in metaverses gain responsibilities for user-supplied content conduct within the metaverse, it is important to provide a transparent and impartial system for managing that content and conduct.

### SUMMARY OF THE INVENTION

In one aspect, embodiments of the present disclosure are directed to a method for managing participant permissions within a computer-implemented metaverse. The method comprising the step of storing unique permissions in a blockchain data structure.

In another aspect, embodiments of the present disclosure are directed to a method for managing transactions involving virtual real estate in a computer-implemented metaverse. In this embodiment, the method includes the steps of permitting a human participant to access the computer-implemented metaverse with a client device, whereupon accessing the computer-implemented metaverse the participant is granted control of an avatar that is linked to an account assigned to the participant, identifying a virtual real estate parcel within the computer-implemented metaverse for sale by a seller, wherein attributes about the target virtual real estate parcel are stored within a blockchain data structure that is administered within the computer-implemented metaverse, and verifying with the blockchain data structure that the seller is the owner of record of the target virtual real estate parcel.

The method also includes the steps of purchasing the target virtual real estate parcel from the seller. The step of purchasing the target virtual real estate parcel from the seller includes the steps of transferring funds from the account assigned to the participant to an account assigned to the seller, and recording in the blockchain data structure the transfer of the virtual real estate parcel from the account assigned to the seller to the account assigned to the participant.

In yet another embodiment, the present disclosure is directed to a method for managing the providence of a unique virtual item within a computer-implemented metaverse. The method includes the steps of placing information about attributes for the unique item in a block within a blockchain data structure, wherein the attributes include information about a first user that possesses the unique item in the computer-implemented metaverse. The method also includes the steps of initiating the transfer of the unique virtual item from the first user to a second user, verifying with the blockchain data structure that the first user is the owner of record of the unique virtual item, and transferring the unique virtual item to the second user and recording the transfer within the blockchain data structure.

### BRIEF DESCRIPTION OF DRAWINGS

FIG. 1 is a functional depiction of a multi-server implementation of an online environment.

FIG. 2 depicts an online market square within the online environment of FIG. 1.

FIG. 3 depicts a blockchain synchronization scheme for a blockchain-based function deployed within the online environment.

FIG. 4 depicts a portion of a blockchain that can be used to assign and manage permissions and property rights within the online environment.

### WRITTEN DESCRIPTION

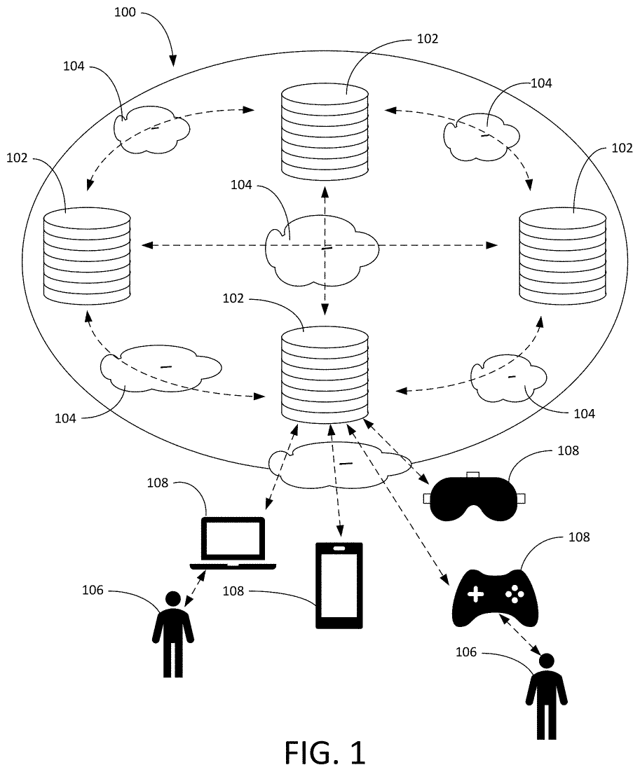

Referring first to FIG. 1, shown therein is a depiction of a metaverse 100 that resides on a plurality of host computer systems 102. The host computers systems 102 may be servers that are interconnected in one or more locations by data networks 104. As used herein, the term “metaverse” should be interpreted with prevailing definitions to mean a live and persistent online environment with both planned and spontaneous events occurring. The metaverse 100 can be configured to provide online gaming, tournaments, online shopping and markets, civic and educational resources, and social platforms.

Participants 106 can connect into the metaverse 100 through client devices 108. Client devices 108 include, for example, computers, mobile phones, video game consoles and virtual reality equipment. It will be appreciated that participants 106 may be provided with the ability to add, modify and remove certain content in the metaverse 100.

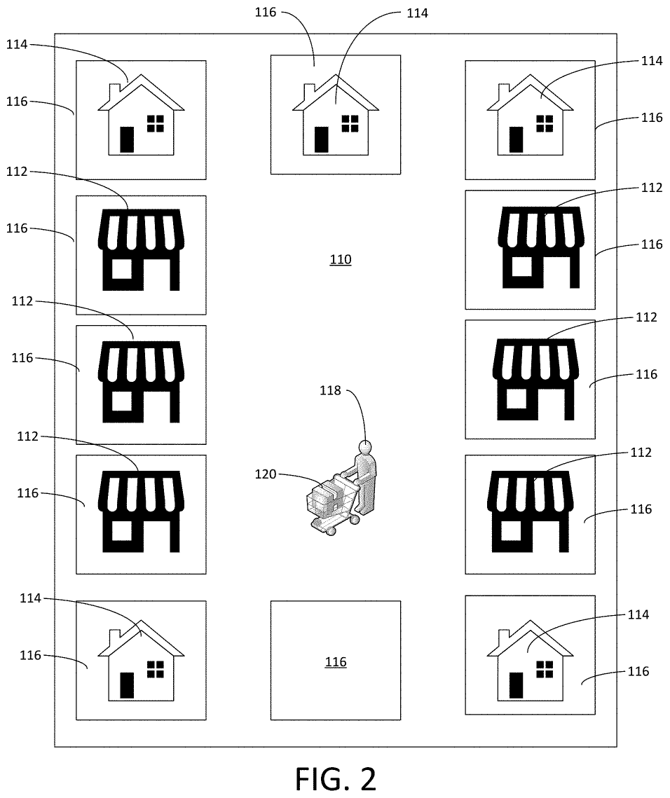

Turning to FIG. 2, shown therein is a virtual plaza 110 within the metaverse 100. The virtual plaza 110 includes one or more virtual storefronts 112 and one or more virtual residences 114. Each of the storefronts 112 and residences 114 is located on a parcel 116 that exists within the plaza 110. Participants 106 may enter the plaza 110 and interact with the storefronts 112, residences 114 and other facilities and functions within the plaza 110 through avatars 118. It will be appreciated that in some embodiments, the plaza 110 and other locations within the metaverse 110 are rendered in a three-dimensional format and the participants 106 can engage with objects, characters and other participants 106 in a first-person, virtual reality mode.

The storefronts 112 can be configured to connect to external online shopping outlets that allow the participants 106 to browse and order real merchandise for delivery to a real-world address. For example, a participant 106 could visit a sports team-themed storefront 112 and purchase a hat that would be delivered to the participant's real-world home. These transactions can take place with conventional monetary exchange systems, including the use of credit card payment processors, virtual and digital currencies, or in-game credits previously acquired by the participants 106.

In other instances, a storefront 112 can be configured to offer merchandise or services to be delivered or rendered in the metaverse 100, such as such as clothing or items for avatars 118 or furnishings for the residences 114.

Merchandise purchased through a storefront 112 can be a common item 120, or a unique item 122. Common items 120 may include items that are consumable or expendable within the metaverse 100. In contrast, unique items 122 are rare or singular items for which a limited number of such items are available. For example, a virtual sword with unique properties that cannot be replicated within the metaverse 100 would qualify as a unique item 122.

The storefronts 112 can also be used to offer services to the participants 106. For example, one or more of the storefronts 112 can be configured to provide virtual real estate services to permit the sale and conveyance of parcels 116 to participants within the metaverse 100. Other storefronts 112 can be configured to provide advertising services, design services for unique items 122, and educational or training services.

To optimize the experience within the metaverse 100, it is important to find a balance based on the exclusivity of certain features, functions and items. If, for example, every participant 106 was permitted to sell parcels 116 or construct unique items 122, the supply of such services and objects would quickly outstrip demand. Accordingly, to balance the experience with the metaverse 100, licenses 124 are used to restrict the availability of certain functions. For example, a participant 106 would need a specific “real estate” license 124 to be entitled to sell a parcel 116 to another participant. A “construction” license 124 might be required to build a storefront 112 or residence 114 on the purchased parcel 116. A shopkeeper license 124 might be required to open and operate a storefront 112 within the metaverse 100. Because the successful, balanced operation of the metaverse 100 depends on controlling the availability of property (e.g., parcel 116 and unique item 122) and services (e.g., license 124), it is important to control the establishment, transfer and ownership of these concepts.

To address the need for a secure mechanism for controlling content and conduct within the metaverse 100, blockchain data structures 126 are used to manage the secure issuance, registration and transfer of objects, property, permissions and licenses within the metaverse 100. As used herein, the term “blockchain data structure” refers to a computer-implemented program that provides a decentralized ledger or database configured to store information in a secure manner that is not controlled by a single source or issuing organization. The use of blockchain data structures 126 in the metaverse 100 is particularly appealing because it alleviates concerns about whether the entity operating the metaverse 100 is showing favoritism towards particular participants 106.

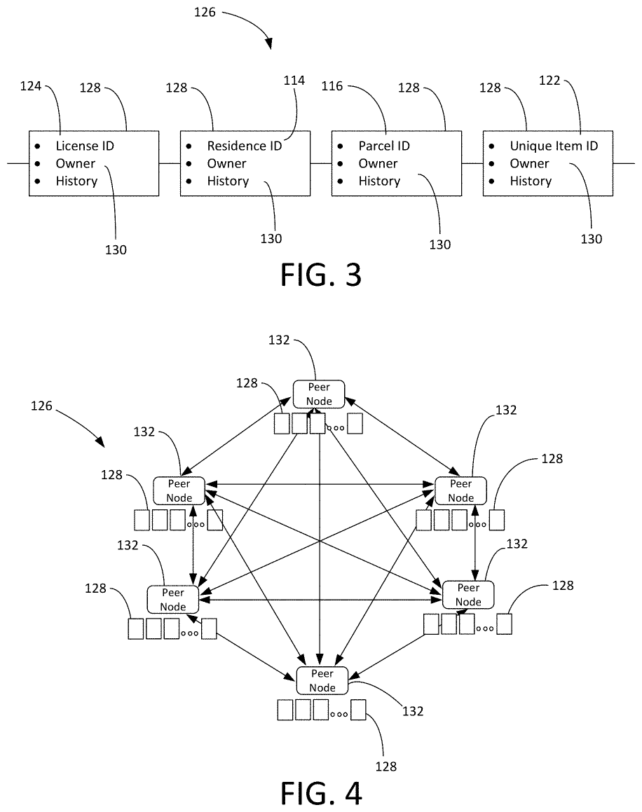

As illustrated in FIG. 3, the blockchain data structure 126 includes a dynamic list of records that are stored as blocks 128, which are linked together using cryptography. Each block 128 contains a cryptographic hash of the previous block 128 and transaction attributes 130, including a timestamp that proves the transaction data existed when the block 128 was published in order to get into its hash. Because blocks 128 within the blockchain data structure 126 each contain information about the block 128 before it, they form a chain-like structure, with each additional block 128 reinforcing the ones before it. This frustrates efforts to change the transaction attributes 130 in any one block 128 because the record of earlier transactions is maintained across multiple linked blocks 128.

Multiple blockchain data structures 126 may be deployed within the metaverse 100, with separate blockchain data structures 126 allocated for separate objects, property or permissions. In the example identified in FIG. 3, the blockchain data structure 126 includes certain blocks 128 directed at permissions, with other blocks 128 directed at properties. In each case, the attributes 130 stored within each block 128 provide an encrypted transaction record of a particular property or permission, together with a confirmation of earlier blocks 128 within the blockchain data structure 126.

Additionally, as illustrated in FIG. 4, the blockchain data structure 126 is configured to be authenticated by multiple nodes 132 within the metaverse 100. The multiple nodes 132 can be distributed across multiple host computer systems 102 to further secure the blockchain data structure 126 against unauthorized manipulation.

In addition to having multiple redundant peer nodes 132, another important feature of the blockchain data structure 126 is the blockchain data itself. Blockchain data structures are similar to a database that is synchronized across all peer nodes 132 in the metaverse 100. The peer nodes 132 decide through a consensus mechanism whether a new transaction on the blockchain data structure 126 is valid. The consensus mechanism used is independent to the metaverse 100. Suitable consensus mechanisms include, but are not limited to, proof-of-work, proof-of-stake, proof-of-importance, and proof-of-authority. In generally, when the majority of the peer nodes 132 reaches a consensus that a particular block 128 is valid, then the block 128 is added within the blockchain data structure 126. If the majority of peer nodes 132 concludes that the block 128 is not valid, the block 128 is excluded from the blockchain data structure 126.

As noted above, the blockchain data structure 126 can be used and configured to securely store information about property within the metaverse such as parcels 116, residences 114, storefronts 112, common items 120 and unique items 122. In some embodiments, the blockchain data structure 126 can be configured as to store information about particular items 120, 122 as fungible or non-fungible tokens. For example, a unique item 122 such as a powerful weapon in a metaverse 100 directed at gaming could be stored and transferred within the metaverse as a non-fungible token (NFT). Generally, a non-fungible token (NFT) is a unit of data stored on a block 128 within the blockchain data structure 126, that verifies that the unique item 122 is truly unique and not interchangeable. Tracking the ownership of unique items 122 or unique parcels 116 as non-fungible tokens ensures that the ownership of these unique items is at all times subject to verification.

In some embodiments and for some applications, the blockchain data structure 126 can employ the same basic cryptography techniques used in cryptocurrency applications. Cryptocurrency blockchains are the earliest use of blockchains and are quite simple. They are merely meant to facilitate the transfer of a specific token, such as a common item 120 or the exchange of currency within the metaverse 100. Their function is to maintain a ledger record of currencies or items, together with the transaction history of those items or payments.

In other embodiments and applications, basic cryptocurrency models are insufficient. For example, when issuing, recording, transferring or destroying a particular permission or license within the metaverse 100, it is necessary to provide additional, self-executing features within the blockchain data structure 126. For these applications and embodiments, the blockchain data structure 126 is configured as a “smart-contract” blockchain.

Smart-contract blockchains differ significantly from traditional cryptocurrency blockchains. The nodes in a smart-contract blockchain do more than just verify transactions and write them to the chain. Instead, each block 128 within a smart-contract blockchain data structure 126 acts like run-time environment for custom programs called “smart-contracts.” The smart-contract programs are stored within the blocks 128 and wait to be called into execution. These programs can perform calculations and can write new data to the blockchain making them highly customizable.

The smart-contract blockchain data structure 126 is particularly well-suited for use in storing information about deeds, licenses and permissions within the metaverse 100. For example, the operators of the metaverse 100 can store a license 124 to sell real estate parcels 116 within a particular virtual plaza 110 on a smart-contract blockchain data structure 126. When the particular block 128 that contains the real estate license 124 is issued to a participant 106, the smart contract executes by assigning the right to sell real estate to the specific participant 106, while securely recording the conveyance of that license on the blockchain data structure 126. If the participant 106 later loses the license 124 to sell the real estate, the permission is revoked and the revocation transaction is recorded on the smart-contract blockchain data structure 126. The use of smart-contract blockchain data structure 126 is a unique and novel way to grant, transfer and revoke licenses 124 (such as a real estate sales license), real property (such as parcels 116, residences 114 and storefronts 112) and unique items 122 that are imbued with function-granting characteristics.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept.

For example, although the blockchain data structures 126 have been disclosed in connection with a deployment within a virtual metaverse 100, it will be appreciated that the same data structures and methods can be deployed to track the issuance, transfer and destruction of deeds, licenses and property rights in the real world. The blockchain-based systems and methods disclosed herein can easily be adapted to track deeds for real property, titles for automobiles and exchanges of cryptocurrencies.

It is claimed:

1. A method for managing participant permissions within a computer-implemented metaverse, the method comprising the step of storing unique permissions in a blockchain data structure.

2. The method of claim 1, wherein the unique permissions comprise licenses that authorize a participant in the metaverse to perform specific tasks within the metaverse.

3. The method of claim 1, wherein the blockchain data structure comprises a plurality of blocks and wherein one or more of the plurality of blocks includes a smart contract.

4. The method of claim 1, further comprising the step of storing virtual property records on the blockchain data structure.

5. The method of claim 4, further comprising the step of storing transaction attributes for the unique permissions and virtual property records on the blockchain data structure.

6. The method of claim 1, further comprising the step of validating the blockchain data structure through multiple nodes within the computer-implemented metaverse.

7. A method for managing the providence of a unique virtual item within a computer-implemented metaverse, the method comprising the steps of:
placing information about attributes for the unique item in a block within a blockchain data structure, wherein the attributes include information about a first user that possesses the unique item in the computer-implemented metaverse;
initiating the transfer of the unique virtual item from the first user to a second user;
verifying with the blockchain data structure that the first user is the owner of record of the unique virtual item; and
transferring the unique virtual item to the second user and recording the transfer within the blockchain data structure.

8. The method of claim 7, wherein the unique virtual item is an object within the computer-implemented metaverse.

9. The method of claim 7, wherein the unique virtual item is a parcel of virtual real estate.

10. The method of claim 7, wherein the blockchain data structure comprises a plurality of blocks and wherein one or more of the plurality of blocks includes a smart contract.

11. The method of claim 7, further comprising the step of validating the blockchain data structure through multiple nodes within the computer-implemented metaverse.

12. A method for managing transactions involving virtual real estate in a computer-implemented metaverse, the method comprising the steps of:
permitting a human participant to access the computer-implemented metaverse with a client device, whereupon accessing the computer-implemented metaverse the participant is granted control of an avatar that is linked to an account assigned to the participant;
identifying a virtual real estate parcel within the computer-implemented metaverse for sale by a seller, wherein attributes about the target virtual real estate parcel are stored within a blockchain data structure that is administered within the computer-implemented metaverse;
verifying with the blockchain data structure that the seller is the owner of record of the target virtual real estate parcel; and
purchasing the target virtual real estate parcel from the seller, wherein the step of
purchasing the target virtual real estate parcel from the seller comprises:
transferring funds from the account assigned to the participant to an account assigned to the seller; and
recording in the blockchain data structure the transfer of the virtual real estate parcel from the account assigned to the seller to the account assigned to the participant.

13. The method of claim 12, further comprising the step of verifying that the seller has an appropriate permission to sell the target virtual real estate parcel, wherein the step of verifying the seller's permission comprises verifying the presence of a virtual realtor license stored within the blockchain data structure.

14. The method of claim 12, further comprising the step of validating the blockchain data structure through multiple nodes within the computer-implemented metaverse.

15. The method of claim 12, wherein the target virtual real estate parcel is included within a virtual plaza that comprises multiple real estate parcels.
